(19) United States
(12) Patent Application Publication
(10) Pub. No.: US 2024/0331929 A1
(43) Pub. Date: Oct. 3, 2024

(54) COIL COMPONENT

(71) Applicant: TDK CORPORATION, Tokyo (JP)

(72) Inventors: Keito YASUDA, Tokyo (JP); Yusuke Nagai, Tokyo (JP); Makoto Yoshino, Tokyo (JP); Masaki Takahashi, Tokyo (JP); Shinichi Sato, Tokyo (JP); Yuya Ishima, Tokyo (JP); Shingo Hattori, Tokyo (JP); Youhei Iida, Tokyo (JP); Mitsuharu Koike, Tokyo (JP); Takato Sasaki, Tokyo (JP)

(73) Assignee: TDK CORPORATION, Tokyo (JP)

(21) Appl. No.: 18/404,362

(22) Filed: Jan. 4, 2024

(30) Foreign Application Priority Data
Mar. 30, 2023 (JP) 2023-054944

(51) Int. Cl. H01F 27/29; H01F 27/28

(52) U.S. Cl. CPC H01F 27/292; H01F 27/2804; H01F 2027/2809

(57) ABSTRACT

A coil component 1 includes an element body having a mounting surface, a coil disposed in the element body, terminal electrodes disposed on the mounting surface of the element body, and a first connection conductor and a second connection conductor connecting the coil and the terminal electrodes, respectively, in which the first connection conductor and the second connection conductor have first portions connected to the terminal electrodes, second portions connected to the coil, and third portions connecting the first portions and the second portions, respectively, and an area of a first pore per unit area in the first portion is larger than an area of a third pore per unit area in the third portion.

### TECHNICAL FIELD

The present disclosure relates to a coil component.

### BACKGROUND

One of coil components described in, for example, Patent Literature 1 is known. A coil component described in Patent Literature 1 (Japanese Unexamined Patent Publication No. 2018-56197) includes an element body formed by laminating a plurality of magnetic layers, a coil disposed in the element body and configured to include a plurality of conductor patterns electrically connected to each other, a terminal electrode disposed on a mounting surface of the element body, and a connection conductor connecting the coil and the terminal electrode.

### SUMMARY

In the coil component, when stress is applied to a connection portion between the connection conductor and another conductor, the connection conductor is easily separated from the another conductor, and as a result, the connection conductor and the another conductor may be disconnected.

An object of one aspect of the present disclosure is to provide a coil component capable of suppressing disconnection between a connection conductor and another conductor.
(1) A coil component according to one aspect of the present disclosure includes: an element body having a mounting surface; a coil disposed in the element body; a terminal electrode disposed on the mounting surface of the element body; and a connection conductor connecting the coil and the terminal electrode, in which the connection conductor has a first portion connected to the terminal electrode, a second portion connected to the coil, and a third portion connecting the first portion and the second portion, the first portion is provided with a plurality of first holes, the third portion is provided with a plurality of third holes, and an area of the first hole per unit area in the first portion is larger than an area of the third hole per unit area in the third portion.

In the coil component according to one aspect of the present disclosure, the area of the first hole per unit area in the first portion is larger than the area of the third hole per unit area in the third portion. As a result, in the coil component, a large number of first holes exist in a connection portion between the first portion and the terminal electrode. Therefore, in the coil component, even when stress is applied to the connection portion between the connection conductor and the terminal electrode, the stress can be alleviated. Thus, in the coil component, disconnection between the connection conductor and another conductor (terminal electrode) can be suppressed.
(2) A coil component according to one aspect of the present disclosure includes: an element body having a mounting surface; a coil disposed in the element body; a terminal electrode disposed on the mounting surface of the element body; and a connection conductor connecting the coil and the terminal electrode, in which the connection conductor has a first portion connected to the terminal electrode, a second portion connected to the coil, and a third portion connecting the first portion and the second portion, the second portion is provided with a plurality of second holes, the third portion is provided with a plurality of third holes, and an area of the second hole per unit area in the second portion is larger than an area of the third hole per unit area in the third portion.

In the coil component according to one aspect of the present disclosure, the area of the second hole per unit area in the second portion is larger than the area of the third hole per unit area in the third portion. As a result, in the coil component, a large number of second holes exist in a connection portion between the second portion and the coil. Therefore, in the coil component, even when stress is applied to the connection portion between the connection conductor and the coil, the stress can be alleviated. Thus, in the coil component, disconnection between the connection conductor and another conductor (coil) can be suppressed.
(3) In the coil component according to (1), in at least some of the first holes among the plurality of first holes provided on a contact surface with the terminal electrode in the first portion, a part of the terminal electrode may enter the at least some of the first holes. In this configuration, the bonding strength between the terminal electrode and the first portion of the connection conductor can be improved by an anchor effect.
(4) In the coil component according to (2), in at least some of the second holes among the plurality of second holes provided on a contact surface with the coil in the second portion, a part of the coil may enter the at least some of the second holes. In this configuration, the bonding strength between the coil and the second portion of the connection conductor can be improved by an anchor effect.
(5) In the coil component according to any one of (1) to (3), the terminal electrode may be a plated electrode.
(6) In the coil component according to any one of (1) to (4), the coil may include a plurality of plated conductors electrically connected to each other.

According to one aspect of the present disclosure, disconnection between the connection conductor and another conductor can be suppressed.

### BRIEF DESCRIPTION OF THE DRAWINGS

FIG. 1 is a perspective view illustrating a coil component according to an embodiment;

FIG. 2 is a transparent perspective view of the coil component illustrated in FIG. 1;

FIG. 3 is an exploded perspective view of the coil component;

FIG. 4A is a schematic view illustrating a first connection conductor, a first terminal electrode, and a coil, and FIG. 4B is a schematic view illustrating a first connection conductor, a first terminal electrode, and a coil; and

FIG. 5A is a schematic enlarged cross-sectional view illustrating a connection portion between a second portion and a coil, FIG. 5B is a schematic cross-sectional view of a third portion, and FIG. 5C is a schematic enlarged cross-sectional view illustrating a connection portion between a first portion and a terminal electrode.

### DETAILED DESCRIPTION

Hereinafter, preferred embodiments of the present disclosure will be described in detail with reference to the accompanying drawings. Note that the same or corresponding elements in the description of the drawings are denoted by the same reference signs, and redundant description is omitted.

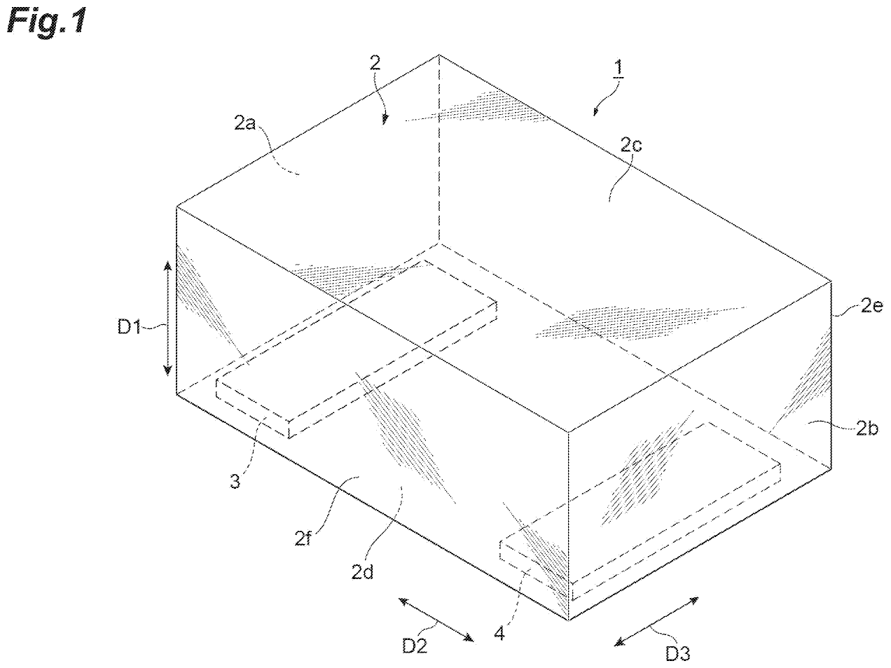

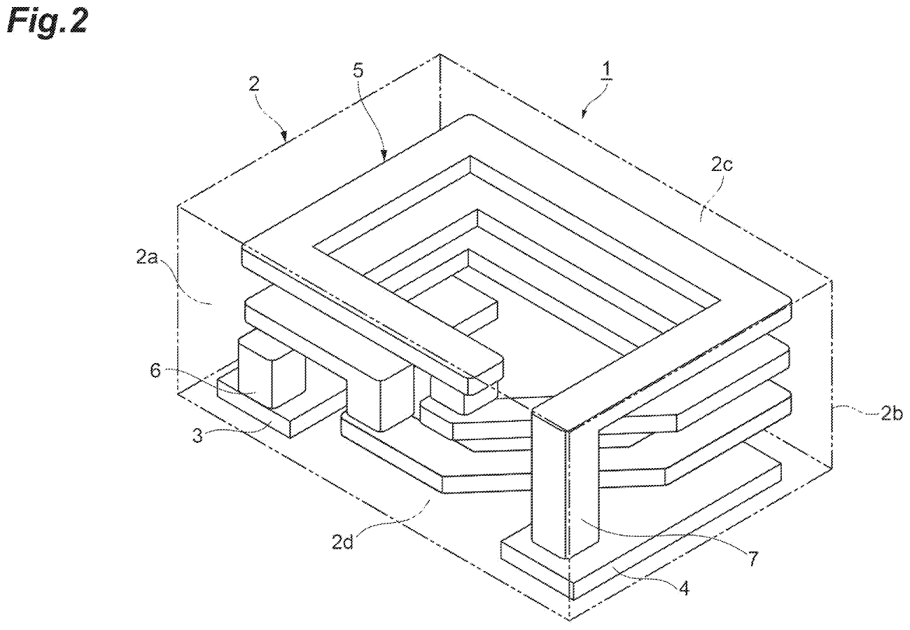

A coil component will be described with reference to FIGS. 1 and 2. FIG. 1 is a perspective view illustrating a coil component according to an embodiment. FIG. 2 is a transparent perspective view of the coil component illustrated in FIG. 1. As illustrated in FIGS. 1 and 2, a coil component 1 includes an element body 2, terminal electrodes 3 and 4, a coil 5, and first and second connection conductors 6 and 7. In FIG. 2, the element body 2 is indicated by a broken line for convenience of description.

The element body 2 has a rectangular parallelepiped shape. The rectangular parallelepiped shape includes a rectangular parallelepiped shape in which corner portions and ridge line portions are chamfered, or a rectangular parallelepiped shape in which corner portions and ridge line portions are rounded. The element body 2 has, as outer surfaces, a pair of end surfaces 2a and 2b, a pair of main surfaces 2c and 2d, and a pair of side surfaces 2e and 2f. The end surfaces 2a and 2b face each other. The main surfaces 2c and 2d face each other. The side surfaces 2e and 2f face each other. Hereinafter, an opposing direction of the main surfaces 2c and 2d is referred to as a first direction D1, an opposing direction of the end surfaces 2a and 2b is referred to as a second direction D2, and an opposing direction of the side surfaces 2e and 2f is referred to as a third direction D3. The first direction D1, the second direction D2, and the third direction D3 are substantially orthogonal to each other.

The end surfaces 2a and 2b extend in the first direction D1 so as to connect the main surfaces 2c and 2d. The end surfaces 2a and 2b also extend in the third direction D3 so as to connect the side surfaces 2e and 2f. The main surfaces 2c and 2d extend in the second direction D2 so as to connect the end surfaces 2a and 2b. The main surfaces 2c and 2d also extend in the third direction D3 so as to connect the side surfaces 2e and 2f. The side surfaces 2e and 2f extend in the first direction D1 so as to connect the main surfaces 2c and 2d. The side surfaces 2e and 2f also extend in the second direction D2 so as to connect the end surfaces 2a and 2b.

The main surface 2d is a mounting surface, and is, for example, a surface facing another electronic device (for example, a circuit substrate or a laminated electronic component) (not illustrated) when the coil component 1 is mounted on the another electronic device. The end surfaces 2a and 2b are surfaces continuous from the mounting surface (that is, the main surface 2d).

The length of the element body 2 in the second direction D2 is longer than the length of the element body 2 in the first direction D1 and the length of the element body 2 in the third direction D3. The length of the element body 2 in the third direction D3 is longer than the length of the element body 2 in the first direction D1. That is, in the present embodiment, the end surfaces 2a and 2b, the main surfaces 2c and 2d, and the side surfaces 2e and 2f have a rectangular shape. The length of the element body 2 in the first direction D1 may be equivalent to the length of the element body 2 in the third direction D3, or many be shorter than the length thereof.

It should be noted that “equivalent” in the present embodiment may mean not only “equal” but also a value including a slight difference, a manufacturing error, or the like in a preset range. For example, it is defined that a plurality of values are equivalent insofar as the plurality of values are included in the range of 95% to 105% of the average value of the plurality of values.

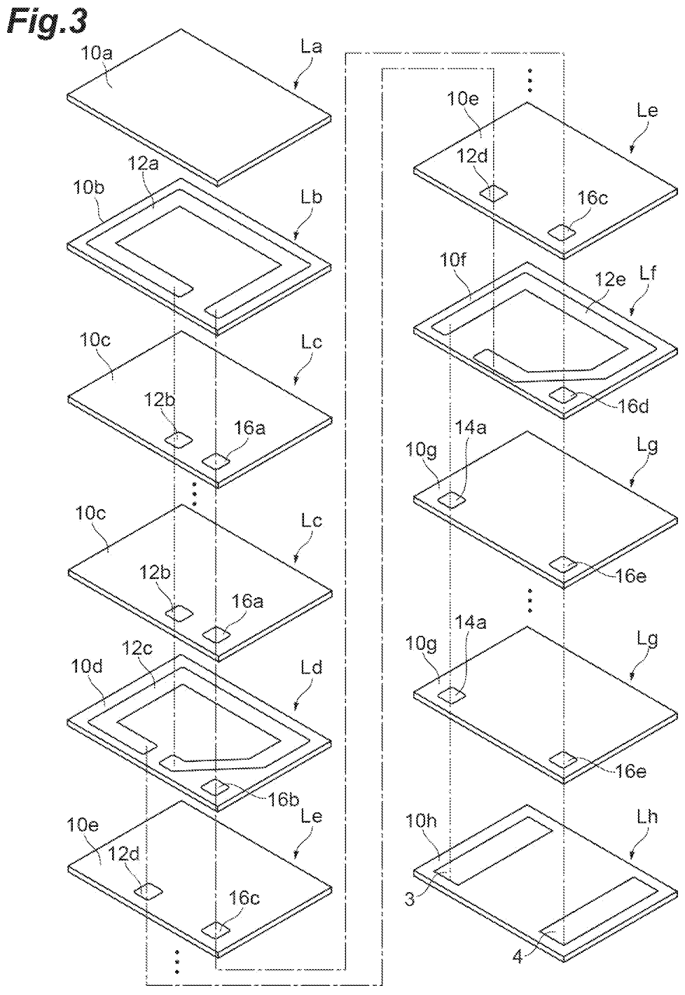

The element body 2 is formed by laminating a plurality of element body layers (insulator layers) 10a to 10h (see FIG. 3) in the first direction D1. That is, the lamination direction of the element body 2 is the first direction D1. A specific laminated configuration will be described below. In the actual element body 2, the plurality of element body layers 10a to 10h are integrated to such an extent that boundaries between the element body layers cannot be visually recognized. The element body layers 10a to 10h are made of, for example, a magnetic material (a Ni—Cu—Zn-based ferrite material, a Ni—Cu—Zn—Mg-based ferrite material, a Ni—Cu-based ferrite material, or the like). The magnetic material constituting the element body layers 10a to 10h may contain a Fe alloy or the like. The element body layers 10a to 10h may be made of a non-magnetic material (a glass ceramic material, a dielectric material, or the like).

Each of the terminal electrode 3 and the terminal electrode 4 is provided in the element body 2. Each of the terminal electrode 3 and the terminal electrode 4 is disposed on the main surface 2d of the element body 2. The terminal electrode 3 and the terminal electrode 4 are provided in the element body 2 so as to be separated from each other in the second direction D2. Specifically, the terminal electrode 3 is disposed on the end surface 2a side of the element body 2. The terminal electrode 4 is disposed on the end surface 2b side of the element body 2.

Each of the terminal electrode 3 and the terminal electrode 4 has a rectangular shape. Each of the terminal electrode 3 and the terminal electrode 4 is disposed such that the longitudinal direction is along the third direction D3 and the lateral direction is along the second direction D2. The terminal electrode 3 and the terminal electrode 4 protrude from the main surface 2d. That is, in the present embodiment, the surfaces of the terminal electrode 3 and the terminal electrode 4 are not flush with the main surface 2d.

Each of the terminal electrode 3 and the terminal electrode 4 is made of, for example, a conductive material such as Cu, Ni, Sn, or Au. In the present embodiment, each of the terminal electrode 3 and the terminal electrode 4 is a plated electrode formed by plating (electrolytic plating or electroless plating). Each of the terminal electrode 3 and the terminal electrode 4 may have a single-layer structure or a multi-layer structure.

The coil 5 is disposed in the element body 2. The coil 5 is configured by a plurality of coil conductor layers 12a to 12e (see FIG. 3). The plurality of coil conductor layers 12a to 12e are electrically connected to each other and constitute the coil 5 in the element body 2. The coil axis of the coil 5 is provided along the first direction D1. The coil conductor layers 12a to 12e are disposed in such a way as to at least partially overlap each other as viewed from the first direction D1. The plurality of coil conductor layers 12b to 12e are made of a conductive material (for example, Ag or Pd). In the present embodiment, the plurality of coil conductor layers 12a to 12e are plated conductors. The coil conductor layers 12a to 12e are disposed apart from the end surfaces 2a and 2b, the main surfaces 2c and 2d, and the side surfaces 2e and 2f.

The first connection conductor 6 is disposed in the element body 2. The first connection conductor 6 connects the terminal electrode 3 and the coil 5. The first connection conductor 6 is a through-hole conductor. The first connection conductor 6 extends in the first direction D1 and is connected to the terminal electrode 3 and one end of the coil 5. The first connection conductor 6 is configured by a plurality of first connection conductor layers 14a (see FIG. 3). In the present embodiment, the first connection conductor 6 has a rectangular cross section (cross section along the second direction D2 and the third direction D3) orthogonal to the extension direction (first direction D1). That is, the first connection conductor 6 has a prismatic shape.

The second connection conductor 7 is disposed in the element body 2. The second connection conductor 7 connects the terminal electrode 4 and the coil 5. The second connection conductor 7 is a through-hole conductor. The second connection conductor 7 extends in the first direction D1 and is connected to the terminal electrode 4 and the other end of the coil 5. The second connection conductor 7 is configured by a plurality of second connection conductor layers 16a, 16b, 16c, 16d, and 16e (see FIG. 3). In the present embodiment, the second connection conductor 7 has a rectangular cross section (cross section along the second direction D2 and the third direction D3) orthogonal to the extension direction (first direction D1). That is, the second connection conductor 7 has a prismatic shape.

FIG. 3 is an exploded perspective view of the coil component illustrated in FIG. 1. As illustrated in FIG. 3, the coil component 1 includes a plurality of layers La, Lb, Lc, Ld, Le, Lf, Lg, and Lh. The coil component 1 is configured by, for example, laminating the layers La to Lh in order from the main surface 2c side. The coil component 1 according to the present embodiment includes a plurality of layers Lc and a plurality of layers Lg.

The layer La is configured by the element body layer 10a. The layer La constitutes the main surface 2c of the element body 2.

The layer Lb is configured by mutually combining the element body layer 10b and the coil conductor layer 12a. The element body layer 10b is provided with a defective portion (not illustrated) which has a shape corresponding to the coil conductor layer 12a and into which the coil conductor layer 12a is fitted. The element body layer 10b and the coil conductor layer 12a have a mutually complementary relationship.

The layer Lc is configured by mutually combining the element body layer 10c, the coil conductor layer 12b, and the second connection conductor layer 16a. The element body layer 10c is provided with a defective portion (not illustrated) which has a shape corresponding to the coil conductor layer 12b and the second connection conductor layer 16a and into which the coil conductor layer 12b and the second connection conductor layer 16a are fitted. The element body layer 10c and the entirety of the coil conductor layer 12b and the second connection conductor layer 16a have a mutually complementary relationship.

The layer Ld is configured by mutually combining the element body layer 10d, the coil conductor layer 12c, and the second connection conductor layer 16b. The element body layer 10d is provided with a defective portion (not illustrated) which has a shape corresponding to the coil conductor layer 12c and the second connection conductor layer 16b and into which the coil conductor layer 12c and the second connection conductor layer 16b are fitted. The element body layer 10d and the entirety of the coil conductor layer 12c and the second connection conductor layer 16b have a mutually complementary relationship.

The layer Le is configured by mutually combining the element body layer 10e, the coil conductor layer 12d, and the second connection conductor layer 16c. The element body layer 10e is provided with a defective portion (not illustrated) which has a shape corresponding to the coil conductor layer 12d and the second connection conductor layer 16c and into which the coil conductor layer 12d and the second connection conductor layer 16c are fitted. The element body layer 10e and the entirety of the coil conductor layer 12d and the second connection conductor layer 16c have a mutually complementary relationship.

The layer Lf is configured by mutually combining the element body layer 10f, the coil conductor layer 12e, and the second connection conductor layer 16d. The element body layer 10f is provided with a defective portion (not illustrated) which has a shape corresponding to the coil conductor layer 12e and the second connection conductor layer 16d and into which the coil conductor layer 12e and the second connection conductor layer 16d are fitted. The element body layer 10f and the entirety of the coil conductor layer 12e and the second connection conductor layer 16d have a mutually complementary relationship.

The layer Lg is configured by mutually combining the element body layer 10g, the first connection conductor layer 14a, and the second connection conductor layer 16e. The element body layer 10g is provided with a defective portion (not illustrated) which has a shape corresponding to the first connection conductor layer 14a and the second connection conductor layer 16e and into which the first connection conductor layer 14a and the second connection conductor layer 16e are fitted. The element body layer 10g and the entirety of the first connection conductor layer 14a and the second connection conductor layer 16e have a mutually complementary relationship.

The layer Lh is configured by mutually combining the element body layer 10h, the terminal electrode 3, and the terminal electrode 4. The element body layer 10h is provided with a defective portion (not illustrated) which has a shape corresponding to the terminal electrode 3 and the terminal electrode 4 and into which the terminal electrode 3 and the terminal electrode 4 are fitted. The element body layer 10h and the entirety of the terminal electrode 3 and the terminal electrode 4 have a mutually complementary relationship. The layer Lh constitutes the main surface 2d of the element body 2.

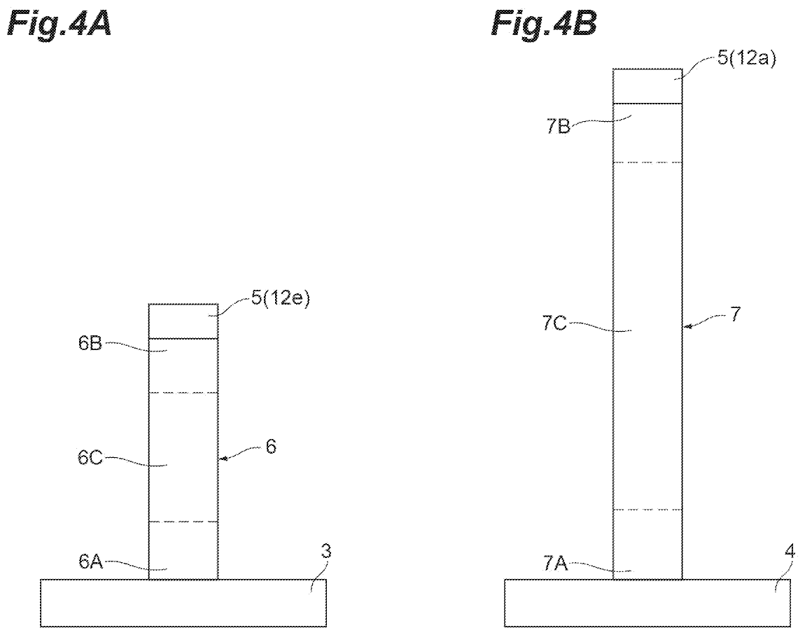

As illustrated in FIG. 4A, the first connection conductor 6 has a first portion 6A, a second portion 6B, and a third portion 6C. The first portion 6A, the second portion 6B, and the third portion 6C are integrally formed. The first portion 6A is connected to the terminal electrode 3. Specifically, the end portion of the first portion 6A on the main surface 2d side is connected to the terminal electrode 3. The second portion 6B is connected to the coil 5 (coil conductor layer 12e). Specifically, the end portion of the second portion 6B on the main surface 2c side is connected to the coil 5. The third portion 6C connects (couples) the first portion 6A and the second portion 6B.

In FIG. 4A, broken lines are shown to distinguish between the first portion 6A and the third portion 6C and between the second portion 6B and the third portion 6C, but the boundary of each portion is not limited to the portion illustrated in FIG. 4A. The first portion 6A may include at least a portion connected to the terminal electrode 3. The second portion 6B may include at least a portion connected to the coil 5.

As illustrated in FIG. 4B, the second connection conductor 7 has a first portion 7A, a second portion 7B, and a third portion 7C. The first portion 7A, the second portion 7B, and the third portion 7C are integrally formed. The first portion 7A is connected to the terminal electrode 4. Specifically, the end portion of the first portion 7A on the main surface 2d side is connected to the terminal electrode 4. The second portion 7B is connected to the coil 5 (coil conductor layer 12a). Specifically, the end portion of the second portion 7B on the main surface 2c side is connected to the coil 5. The third portion 7C connects the first portion 7A and the second portion 7B. In FIG. 4B, broken lines are shown to distinguish between the first portion 7A and the third portion 7C and between the second portion 7B and the third portion 7C, but the boundary of each portion is not limited to the portion illustrated in FIG. 4B.

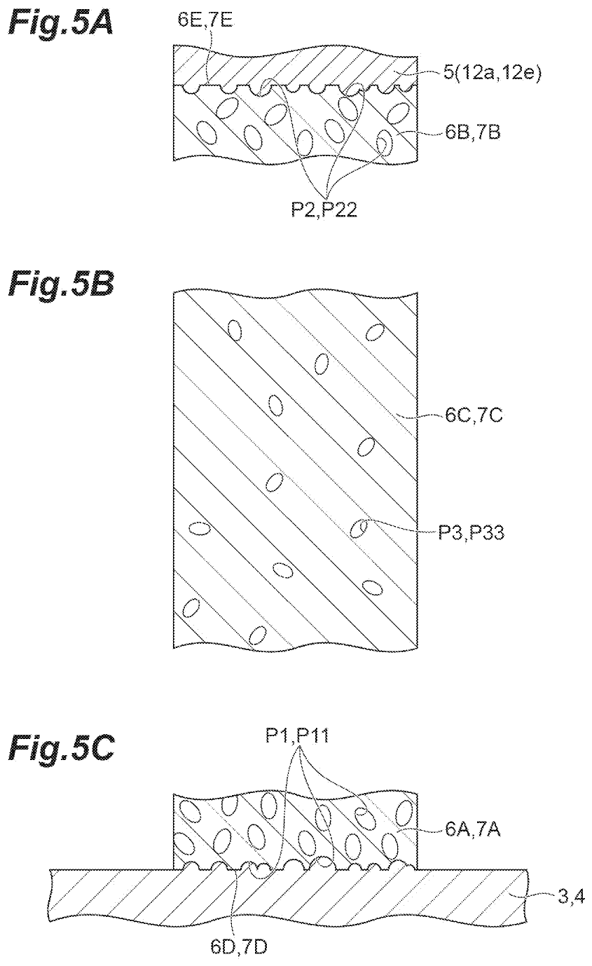

FIG. 5A is a schematic enlarged cross-sectional view illustrating a connection portion between the second portion 6B, 7B and the coil 5, FIG. 5B is a schematic cross-sectional view of a third portion 6C, 7C, and FIG. 5C is a schematic enlarged cross-sectional view illustrating a connection portion between the first portion 6A, 7A and the terminal electrode 3, 4.

The first portion 6A of the first connection conductor 6 is provided with a plurality of first pores (first holes) P1. The second portion 6B is provided with a plurality of second pores (second holes) P2. The third portion 6C is provided with a plurality of third pores (third holes) P3. The first connection conductor 6 is formed in a porous shape. The first pore P1, the second pore P2, and the third pore P3 may be provided independently of each other, or a plurality of these pores may be provided continuously (to be connected to each other). The shapes of the first pore P1, the second pore P2, and the third pore P3 are not particularly limited.

The area of the first pore P1 per unit area in the first portion 6A of the first connection conductor 6 is larger than the area of the third pore P3 per unit area in the third portion 6C. That is, the first portion 6A includes more pores than in the third portion 6C. It can also be said that the volume of the first pore P1 per unit volume in the first portion 6A is larger than the volume of the third pore P3 per unit volume in the third portion 6C. The volume density of the first pore P1 in the first portion 6A is higher than the volume density of the third pore P3 in the third portion 6C. The volume density means a volume occupied by pores per unit volume. The first portion 6A includes more pores than in the third portion 6C. Accordingly, the density per unit volume of the first portion 6A is sparser than that of the third portion 6C. Therefore, it can be said that the density per unit volume of the first portion 6A is lower than the density per unit volume of the third portion 6C.

As illustrated in FIG. 5C, the plurality of first pores P1 are provided on a contact surface 6D with the terminal electrode 3 in the first portion 6A. In the contact surface 6D, the first pore P1 forms a recess. In at least some of the first pores P1 among the plurality of first pores P1 provided on the contact surface 6D, a part of the terminal electrode 3 enters the at least some of the first pores P1. In the example illustrated in FIG. 5C, the terminal electrode 3 enters all the first pores P1 provided on the contact surface 6D.

The area of the second pore P2 per unit area in the second portion 6B of the first connection conductor 6 is larger than the area of the third pore P3 per unit area in the third portion 6C. That is, the second portion 6B includes more pores than in the third portion 6C. It can also be said that the volume of the second pore P2 per unit volume in the second portion 6B is larger than the volume of the third pore P3 per unit volume in the third portion 6C. The volume density of the second pore P2 in the second portion 6B is higher than the volume density of the third pore P3 in the third portion 6C. The second portion 6B includes more pores than in the third portion 6C. Accordingly, the density per unit volume of the second portion 6B is sparser than that of the third portion 6C. Therefore, it can be said that the density per unit volume of the second portion 6B is lower than the density per unit volume of the third portion 6C.

As illustrated in FIG. 5A, the plurality of second pores P2 are provided on a contact surface 6E with the coil 5 (coil conductor layer 12e) in the second portion 6B. In the contact surface 6E, the second pore P2 forms a recess. In at least some of the second pores P2 among the plurality of second pores P2 provided on the contact surface 6E, a part of the coil 5 enters the at least some of the second pores P2. In the example illustrated in FIG. 5A, the coil 5 enters all the second pores P2 provided on the contact surface 6E.

The first portion 7A of the second connection conductor 7 is provided with first pores (first holes) P11. The second portion 7B is provided with second pores (second holes) P22. The third portion 7C is provided with third pores (third holes) P33. The second connection conductor 7 is formed in a porous shape. The first pore P11, the second pore P22, and the third pore P33 may be provided independently of each other, or a plurality of these pores may be provided continuously (to be connected to each other). The shapes of the first pore P11, the second pore P22, and the third pore P33 are not particularly limited.

The area of the first pore P11 per unit area in the first portion 7A of the second connection conductor 7 is larger than the area of the third pore P33 per unit area in the third portion 7C. That is, the first portion 7A includes more pores than in the third portion 7C. It can also be said that the volume of the first pore P11 per unit volume in the first portion 7A is larger than the volume of the third pore P33 per unit volume in the third portion 7C. The volume density of the first pore P11 in the first portion 7A is higher than the volume density of the third pore P33 in the third portion 7C. The first portion 7A includes more pores than in the third portion 7C. Accordingly, the density per unit volume of the first portion 7A is sparser than that of the third portion 7C. Therefore, it can be said that the density per unit volume of the first portion 7A is lower than the density per unit volume of the third portion 7C.

As illustrated in FIG. 5C, the plurality of first pores P11 are provided on a contact surface 7D with the terminal electrode 4 in the first portion 7A. In the contact surface 7D, the first pore P11 forms a recess. In at least some of the first pores P11 among the plurality of first pores P11 provided on the contact surface 7D, a part of the terminal electrode 4 enters the at least some of the first pores P11. In the example illustrated in FIG. 5C, the terminal electrode 4 enters all the first pores P11 provided on the contact surface 7D.

The area of the second pore P22 per unit area in the second portion 7B of the second connection conductor 7 is larger than the area of the third pore P33 per unit area in the third portion 7C. That is, the second portion 7B includes more pores than in the third portion 7C. It can also be said that the volume of the second pore P22 per unit volume in the second portion 7B is larger than the volume of the third pore P33 per unit volume in the third portion 7C. The volume density of the second pore P22 in the second portion 7B is higher than the volume density of the third pore P33 in the third portion 7C. The second portion 7B includes more pores than in the third portion 7C. Accordingly, the density per unit volume of the second portion 7B is sparser than that of the third portion 7C. Therefore, it can be said that the density per unit volume of the second portion 7B is lower than the density per unit volume of the third portion 7C.

As illustrated in FIG. 5A, the plurality of second pores P22 are provided on a contact surface 7E with the coil 5 (coil conductor layer 12a) in the second portion 7B. In the contact surface 7E, the second pore P22 forms a recess. In at least some of the second pores P22 among the plurality of second pores P22 provided on the contact surface 7E, a part of the coil 5 enters the at least some of the second pores P22. In the example illustrated in FIG. 5A, the coil 5 enters all the second pores P22 provided on the contact surface 7E.

An example of a method for manufacturing the coil component 1 according to the embodiment will be described.

Metal magnetic particles, an insulating resin, a solvent, and the like are mixed to prepare a slurry. The prepared slurry is applied onto a substrate (such as a PET film) by a doctor blade method to form green sheets that become the element body layers 10a to 10g. Next, penetrating portions are formed by laser processing at positions where the coil conductor layers 12a to 12e, the first connection conductor layer 14a, and the second connection conductor layers 16a to 16e are to be formed on the green sheet.

Subsequently, a conductive paste is filled in the penetrating portions where the first connection conductor layer 14a and the second connection conductor layers 16a to 16e are to be formed on the green sheet. The conductive paste is produced by mixing a conductive metal powder, a binder resin, and the like. The conductive paste of the first connection conductor layer 14a constituting the first portion 6A and the second portion 6B of the first connection conductor 6 contains a binder resin in a larger amount than the conductive paste of the first connection conductor layer 14a constituting the third portion 6C. The conductive paste of the second connection conductor layers 16a to 16e constituting the first portion 7A and the second portion 7B of the second connection conductor 7 contains a binder resin in a larger amount than the conductive paste of the second connection conductor layers 16a to 16e constituting the third portion 7C. Then, plated conductors that become the coil conductor layers 12a to 12e are provided in the penetrating portions where the coil conductor layers 12a to 12e are to be formed on the green sheet.

Subsequently, the green sheets are laminated. Here, a plurality of the green sheets provided with the plated conductors are peeled off from the substrate and laminated and pressure is applied in the lamination direction to form a laminate. At this time, the green sheets are laminated such that the respective plated conductors that become the coil conductor layers 12a to 12e, the first connection conductor layer 14a, and the second connection conductor layers 16a to 16e overlap in the lamination direction. By adjusting the pressure applied when the green sheets are laminated, the bite amount of the plated conductors (the coil conductor layer 12e and the first connection conductor layer 14a, and the coil conductor layer 12a and the second connection conductor layer 16a) can be adjusted.

Subsequently, the green sheet laminate is cut into chips of a predetermined size with a cutting machine to obtain green chips. Subsequently, the binder resin contained in each portion is removed from the green chip, and then the green chips are fired. By the firing, the binder resin contained in the conductive pastes of the first connection conductor layer 14a and the second connection conductor layers 16a to 16e is removed (decomposed). As a result, pores are formed in the respective portions. As described above, the element body 2 is obtained.

Since the conductive paste of the first connection conductor layer 14a constituting the first portion 6A and the second portion 6B of the first connection conductor 6 contains a binder resin in a larger amount than the conductive paste of the first connection conductor layer 14a constituting the third portion 6C, pores are formed more in the first portion 6A and the second portion 6B than in the third portion 6C of the first connection conductor 6. Since the conductive paste of the second connection conductor layers 16a to 16e constituting the first portion 7A and the second portion 7B of the second connection conductor 7 contains a binder resin in a larger amount than the conductive paste of the second connection conductor layers 16a to 16e constituting the third portion 7C, pores are formed more in the first portion 7A and the second portion 7B than in the third portion 7C of the second connection conductor 7.

Finally, the conductor formed by plating is pressed against and attached to the laminate to form the terminal electrode 3 and the terminal electrode 4. At this time, by adjusting the pressure for pressing the plated conductor, the bite amount of the terminal electrode 3 and the terminal electrode 4 into the first connection conductor 6 (first connection conductor layer 14a) and the second connection conductor 7 (second connection conductor layer 16e) can be adjusted. Through the above steps, the coil component 1 is obtained.

As described above, in the coil component 1 according to the present embodiment, the area of the first pore P1, P11 per unit area in the first portion 6A, 7A is larger than the area of the third pore P3, P33 per unit area in the third portion 6C, 7C. As a result, in the coil component 1, a large number of first pores P1, P11 exist in the connection portion between the first portion 6A, 7A and the terminal electrode 3, 4. Therefore, in the coil component 1, even when stress is applied to the connection portion between the first connection conductor 6 and the terminal electrode 3 and the connection portion between the second connection conductor 7 and the terminal electrode 4, the stress can be alleviated. Thus, in the coil component 1, disconnection between the first connection conductor 6 and the terminal electrode 3 and between the second connection conductor 7 and the terminal electrode 4 can be suppressed.

In the coil component 1 according to the present embodiment, the area of the second pore P2, P22 per unit area in the second portion 6B, 7B is larger than the area of the third pore P3, P33 per unit area in the third portion 6C, 7C. As a result, in the coil component 1, a large number of second pores P2, P22 exist in the connection portion between the second portion 6B, 7B and the coil 5. Therefore, in the coil component 1, even when stress is applied to the connection portion between the first connection conductor 6 and the coil 5 and the connection portion between the second connection conductor 7 and the coil 5, the stress can be alleviated. Thus, in the coil component 1, disconnection between the first connection conductor 6 and the coil 5 and between the second connection conductor 7 and the coil 5 can be suppressed.

In the coil component 1 according to the present embodiment, in at least some of the first pores P1, P11 among the plurality of first pores P1, P11 provided on the contact surface 6D, 7D with the terminal electrode 3, 4 in the first portion 6A, 7A, a part of the terminal electrode 3, 4 enters the at least some of the first pores P1, P11. In this configuration, the bonding strength between the terminal electrode 3 and the first portion 6A of the first connection conductor 6 and between the terminal electrode 4 and the first portion 7A of the second connection conductor 7 can be improved by an anchor effect.

In the coil component 1 according to the present embodiment, in at least some of the second pores P2, P22 among the plurality of second pores P2, P22 provided on the contact surface 6E, 7E with the coil 5 in the second portion 6B, 7B, a part of the coil 5 enters the at least some of the second pores P2, P22. In this configuration, the bonding strength between the coil 5 and the second portion 6B of the first connection conductor 6 and between the coil 5 and the second portion 7B of the second connection conductor 7 can be improved by an anchor effect.

Although the embodiments of the present disclosure have been described above, the present disclosure is not necessarily limited to the above-described embodiments, and various modifications can be made without departing from the gist thereof.

In the above embodiment, a mode in which the area of the first pore P1 per unit area in the first portion 6A of the first connection conductor 6 and the area of the second pore P2 per unit area in the second portion 6B of the first connection conductor 6 are larger than the area of the third pore P3 per unit area in the third portion 6C has been described as an example. However, at least one of the area of the first pore P1 per unit area in the first portion 6A of the first connection conductor 6 and the area of the second pore P2 per unit area in the second portion 6B of the first connection conductor 6 may be larger than the area of the third pore P3 per unit area in the third portion 6C has been described as an example.

Similarly, a mode in which the area of the first pore P11 per unit area in the first portion 7A of the second connection conductor 7 and the area of the second pore P22 per unit area in the second portion 7B of the second connection conductor 7 are larger than the area of the third pore P33 per unit area in the third portion 7C has been described as an example. However, at least one of the area of the first pore P11 per unit area in the first portion 7A of the second connection conductor 7 and the area of the second pore P22 per unit area in the second portion 7B of the second connection conductor 7 may be larger than the area of the third pore P33 per unit area in the third portion 7C has been described as an example.

In the above embodiment, a mode in which the terminal electrode 3, 4 enters all the first pores P1, P11 provided on the contact surface 6D, 7D has been described as an example. However, the terminal electrode 3, 4 may enter some of the first pores P1, P11 provided on the contact surface 6D, 7D. In addition, a mode in which the coil 5 enters all the second pores P2, P22 provided on the contact surface 6E, 7E has been described as an example. However, the coil 5 may enter some of the second pores P2, P22 provided on the contact surface 6E, 7E.

In the above embodiment, a mode in which the terminal electrode 3, 4 is a plated electrode has been described as an example. However, the terminal electrode 3, 4 may be sintered metal electrodes. In this configuration, one or a plurality of plating layers may be formed on the surface of the terminal electrode 3, 4.

In the above embodiment, a mode in which the plurality of coil conductor layers 12b to 12e, the first connection conductor layer 14a, and the second connection conductor layers 16a to 16e are plated conductors has been described as an example. However, the plurality of coil conductor layers 12b to 12e, the first connection conductor layer 14a, and the second connection conductor layers 16a to 16e may be sintered metal conductors.

In the above embodiment, the element body 2 may include a plurality of metal magnetic particles. In this configuration, the metal magnetic particles are made of a soft magnetic alloy (soft magnetic material). The soft magnetic alloy is, for example, a Fe—Si-based alloy. When the soft magnetic alloy is a Fe—Si-based alloy, the soft magnetic alloy may contain P. The soft magnetic alloy may be, for example, a Fe—Ni—Si-M-based alloy. “M” includes one or more elements selected from Co, Cr, Mn, P, Ti, Zr, Hf, Nb, Ta, Mo, Mg, Ca, Sr, Ba, Zn, B, Al, and rare earth elements.

In the above embodiment, a mode in which the coil 5 includes the plurality of coil conductor layers 12b to 12e has been described as an example. However, the number and shape of the coil conductor layers constituting the coil are not limited.

What is claimed is:

1. A coil component comprising:
an element body having a mounting surface;
a coil disposed in the element body;
a terminal electrode disposed on the mounting surface of the element body; and
a connection conductor connecting the coil and the terminal electrode,
wherein the connection conductor has a first portion connected to the terminal electrode, a second portion connected to the coil, and a third portion connecting the first portion and the second portion,
the first portion is provided with a plurality of first holes,
the third portion is provided with a plurality of third holes, and
an area of the first hole per unit area in the first portion is larger than an area of the third hole per unit area in the third portion.

2. A coil component comprising:
an element body having a mounting surface;
a coil disposed in the element body;
a terminal electrode disposed on the mounting surface of the element body; and
a connection conductor connecting the coil and the terminal electrode,
wherein the connection conductor has a first portion connected to the terminal electrode, a second portion connected to the coil, and a third portion connecting the first portion and the second portion,
the second portion is provided with a plurality of second holes,
the third portion is provided with a plurality of third holes, and
an area of the second hole per unit area in the second portion is larger than an area of the third hole per unit area in the third portion.

3. The coil component according to claim 1, wherein in at least some of the first holes among the plurality of first holes provided on a contact surface with the terminal electrode in the first portion, a part of the terminal electrode enters the at least some of the first holes.

4. The coil component according to claim 2, wherein in at least some of the second holes among the plurality of second holes provided on a contact surface with the coil in the second portion, a part of the coil enters the at least some of the second holes.

5. The coil component according to claim 1, wherein the terminal electrode is a plated electrode.

6. The coil component according to claim 1, wherein the coil includes a plurality of plated conductors electrically connected to each other.
